(19) United States
(12) Patent Application Publication
(10) Pub. No.: US 2021/0060911 A1
(43) Pub. Date: Mar. 4, 2021

(54) LIGHTWEIGHT UNDERLAYMENT

(71) Applicant: Intertape Polymer Corp., Sarasota, FL (US)

(72) Inventor: Trevor Arthurs, Truro (CA)

(73) Assignee: Intertape Polymer Corp., Sarasota, FL (US)

(21) Appl. No.: 17/005,906

(22) Filed: Aug. 28, 2020

Related U.S. Application Data
(60) Provisional application No. 62/893,016, filed on Aug. 28, 2019.

(51) Int. Cl. B32B 27/12; E04D 12/00; B32B 5/02; B32B 33/00; B32B 5/26

(52) U.S. Cl. CPC B32B 27/12; E04D 12/002; B32B 5/022; B32B 33/00; B32B 2307/744; B32B 2419/06; B32B 2307/718; B32B 2323/10; B32B 2307/50; B32B 5/26

(57) ABSTRACT

A roofing underlayment and a novel method for manufacturing same is provided. The roofing underlayment comprises a woven scrim bonded with a nonwoven thermoplastic and at least one coating layer disposed on a deck-facing surface of the woven scrim.

### CROSS-REFERENCE TO RELATED APPLICATIONS

This application claims the benefit of U.S. Provisional Application No. 62/893,016, entitled “LIGHTWEIGHT UNDERLAYMENT”, filed Aug. 28, 2019, which is incorporated herein by reference in its entirety.

### TECHNICAL FIELD

The present disclosure provides an underlayment and a novel method for manufacturing same. The underlayment of the present disclosure comprises a woven scrim bonded with a nonwoven, and at least one coating layer disposed on a deck-facing surface of the woven scrim configured for example as a roof underlayment.

### BACKGROUND

In both residential and commercial roofing applications, a roof underlayment is used to provide a water protection barrier among other things. Such primary roof underlayment is used to protect the building interior whether the primary roof covering material is metal panels or shingles, concrete or clay tiles, wood shakes, or slate.

A variety of roofing underlayment products are commonly used. For example, a commercial roofing underlayment product is bituminous asphalt-based felt, commonly referred to as “felt.” Felt comprises paper saturated with asphaltic resins to produce a continuous sheeting material that is processed into short rolls for application. While such felts generally demonstrate good resistance to water ingress and good walkability in dry and wet roof conditions, they have disadvantages including high weight per unit surface area among other things. The weight of such felt underlayments renders application more difficult, especially on sloped roofs.

### SUMMARY

In one example, an underlayment is provided, the underlayment comprising a woven scrim having a first surface defined by a length and a width, and a second opposing surface separated from the first surface by a thickness, a nonwoven sheet adjacent the first surface; and a functional coating attached to the second surface; wherein the nonwoven sheet is ultrasonically bonded to the first surface. In one example, the nonwoven sheet is directly adjacent the woven scrim and the functional coating is directly attached to the second surface. In another example, an adhesive or an adhesive layer is excluded.

In another example, alone or in combination with any one of the previous examples, the woven scrim comprises polypropylene or polypropylene copolymer. In another example, alone or in combination with any one of the previous examples, the woven scrim comprises interwoven tape or fiber arranged in a warp and a weft pattern in a machine direction. In another example, alone or in combination with any one of the previous examples, the woven scrim has an average basis weight of about 35-50 g/m².

In another example, alone or in combination with any one of the previous examples, the nonwoven sheet comprises polypropylene, polyester, polyethylene or polyethylene copolymer. In another example, alone or in combination with any one of the previous examples, the nonwoven sheet has an average basis weight of about 15-25 g/m².

In another example, alone or in combination with any one of the previous examples, the functional coating comprises EPDM, low density polyethylene (LDPE), linear low density polyethylene (LLDPE), plastomer or elastomer, polypropylene and copolymers or terpolymers of polypropylene. In another example, alone or in combination with any one of the previous examples, the functional coating is applied at an average basis weight of about 15-40 g/m².

In another example, alone or in combination with any one of the previous examples, an average total basis weight of the woven scrim, nonwoven sheet, and functional coating is less than 100 g/m². In another example, alone or in combination with any one of the previous examples, an average total basis weight of the woven scrim, nonwoven sheet, and functional coating is less than 90 g/m².

In another example, alone or in combination with any one of the previous examples, the underlayment comprises anti-slip properties and anti-skid properties on the opposing first and second surfaces. In another example, alone or in combination with any one of the previous examples, the woven scrim and/or the nonwoven sheet includes UV resistant material, antimicrobial material, and/or colorant.

### BRIEF DESCRIPTION OF THE DRAWINGS

FIG. 1 is a schematic cross-sectional view of the composite sheet material suitable as an underlayment, in accordance with the present disclosure.

FIGS. 2 and 3 are enlarged, cross-sectional views of example underlayments, respectively, in accordance with the present disclosure.

FIG. 4A illustrates a flowchart of processing steps for making an underlayment in accordance with the present disclosure.

FIG. 4B illustrates a method for making the underlayment of FIG. 4A.

FIG. 5A illustrates a flowchart of processing steps for making an underlayment in accordance with the present disclosure.

FIG. 5B illustrates a method for making the underlayment of FIG. 5A.

### DETAILED DESCRIPTION

Conventional roof underlayments typically comprises a scrim that is barrier coated on the surface intended to be placed adjacent to the roof structure, and an outer layer attached to the opposing surface of the scrim by way of a bonding/adhesion layer, the outer layer essentially providing a sacrificial walkable surface during deployment of the laminate. This conventional roof underlayment laminate construction, while functional, thus requires two bonding layers, among the total of four layers: barrier coating/scrim/coating/outer layer, which adds weight and cost. The present disclosure provides a reduced weight underlayment without sacrificing substantial dimensional stability and performance. The presently disclosed underlayment utilizes ultrasonic bonding of the scrim and outer layer without the need of a bonding/adhesive layer. Therefore, presently disclosed underlayment allows for a reduction in the total weight and cost of the underlayment.

The presently disclosed underlayment comprises a composite laminate sheet material that is flexible, lightweight, resistant to water and resistant to tearing. The composite roofing underlayment provides water barrier properties, breathability, good tensile and tear strength, resistance to UV light, resistance to algae, fungi, mold, and resistance to rot and decay. The presently disclosed underlayment provides environmental protection to the interior of a building and insulating materials underneath.

The underlayment of this disclosure is preferably substantially waterproof. When used for building construction, underlayment of this disclosure preferably is of a relatively resilient structure that can be rolled, bent/folded, but generally does not crease or tear. The underlayment of the present disclosure comprises a woven scrim bonded with a nonwoven sheet and at least one functional coating disposed on a deck-facing surface of the woven scrim as described below.

As used herein, the term “spot welding,” and variations thereof, refer to bonding two or more materials together in a small area, or spot, by the application of ultrasonic energy that directly or indirectly provides heat and/or pressure. Spot welding methods include ultrasonic welding, heated embossing, laser welding and high-pressure welding.

As used herein, the phrases “ultrasonic bonding” and “ultrasonic welding” are used interchangeably and mean a process performed, for example, by passing separate sheets between a sonic horn and anvil roll.

As used herein, the term “machine direction,” or “MD,” refers to the direction of a running, continuous film and/or web during the manufacture of a film laminate. As used herein, the term “cross direction,” or “CD,” refers to the direction that is essentially perpendicular to the machine direction. As used herein, the first surface is defined by a length along the MD and a width along the CD.

As used herein, the terms “including,” “comprising,” or “having” and variations thereof encompass the items listed thereafter and equivalents thereof, as well as additional items.

As used herein, the terms “first,” “second,” and the like are only used to describe elements as they relate to one another, and are in no way meant to recite specific orientations of an article or apparatus, to indicate or imply necessary or required orientations of an article or apparatus, or to specify how an article or apparatus described herein will be used, mounted, or positioned in use.

As used herein, when an element is referred to as being “coupled” or “adjacent” to another element, other elements or intervening elements may be present.

As used herein, when an element is referred to as being “directly coupled” or “directly adjacent” to another element, other elements or intervening elements are not present.

“Basis Weight” is a measure of the mass per unit area of a sheet and was determined by ASTM D-751, which is hereby incorporated by reference, and is reported as an average value in grams per square meter (g/m²).

The presently disclosed roofing is suitable as a Type I and Type II roofing underlayments as specified in Chapter 15 of the IBC (International Building Code), and defined in Chapter 9 of the IRC (International Residential Code); and is also specified as Type 15 and Type 30 underlayments in Chapter 15 of the UBC (Uniform Building Code). The present underlayment will find utility as potential substitutes for these underlayment types, or as a useful underlayment in various roofing construction projects.

In one example, the roofing underlayment of the present disclosure comprises a scrim that is contiguously sandwiched on both its upper and lower surfaces (or deck-facing and non-deck-facing surfaces, relative to a deck surface of a building or structure to be provided with the underlayment). The upper surface or non-deck facing surface of woven scrim 108 is bonded to a nonwoven sheet 112 of a thickness that corresponds to a target average basis weight and the lower surface or deck facing surface of the scrim is coated with a functional coating 210 of a thickness that corresponds to a target average basis weight, such that the total average basis weight of the underlayment is less than or equal to about 90 g/m².

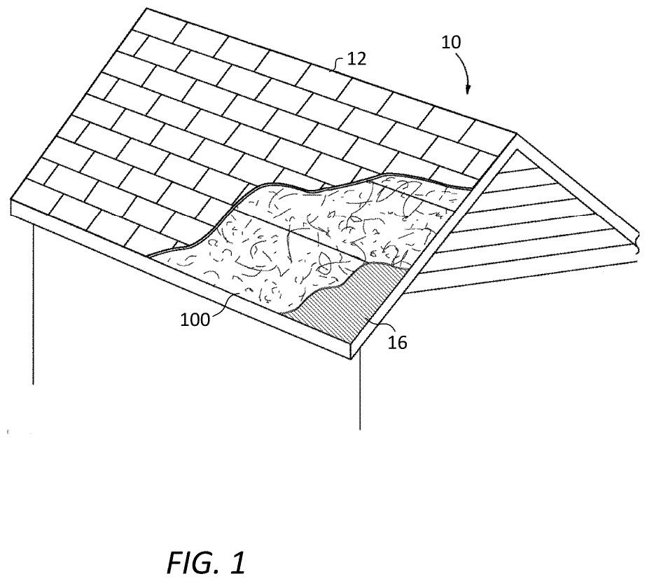

FIG. 1 illustrates a building 10 having a composite laminate sheet underlayment that is in accordance with the present disclosure. A portion of the roofing is not shown to illustrate various components of a roofing system that includes an exterior roof surface 16 or “roof deck,” a layer of underlayment 100 attached to the roof deck, and optionally a multiplicity of courses of roofing shingles 12 attached and overlying the underlayment 100. The underlayment 100 comprises a composite laminate sheet, the individual components thereof described below.

### Woven Scrim Examples

In one example, the woven scrim 108 is a woven fabric. The woven scrim 108 in one example is made from polyolefin materials such as polyethylene, polypropylene, copolymers and other combinations thereof. In another example, the woven scrim 108 is made from polypropylene material and comprises interwoven tape or fiber. In one example, the woven scrim 108 consists of polypropylene or polypropylene copolymers. The woven scrim 108 in one example provides structural reinforcement to the underlayment 100.

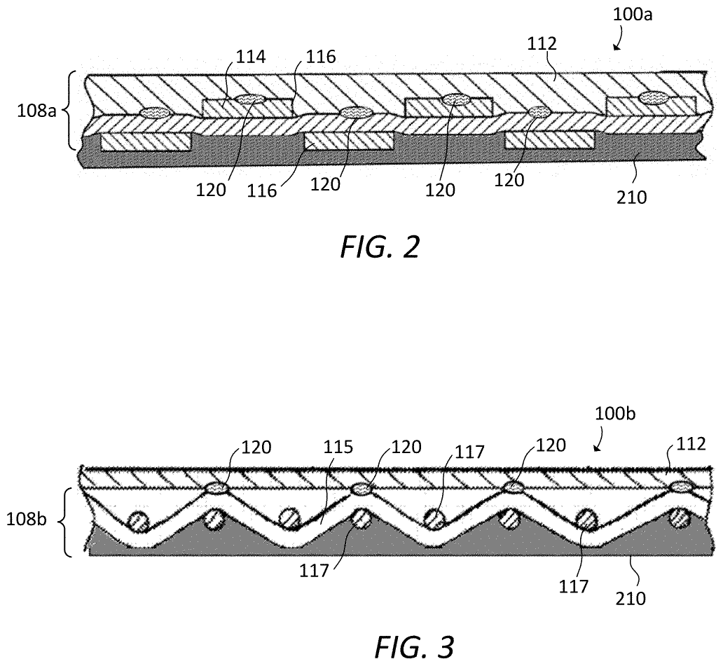

Tapes useful in the woven scrim 108 can be used, for example, at 5-10 tapes per inch (2.5 mm) of about 500-1000 denier polypropylene tape in the warp direction and 4-10 tapes per inch (2.5 mm) of about 500-1000 denier polypropylene tape in the weft direction. With reference to FIGS. 2 and 3, exemplary underlayment construct 100a depicts an exemplary woven scrim 108a formed of a mesh of individual, warp and weft interwoven tapes 114, 116 of material having a tensile strength sufficient to resist tearing when exposed to tensile loads from various directions, whereas exemplary underlayment construct 100b depicts an exemplary woven scrim 108b formed of a mesh of individual interwoven warp and welt fibers 115, 117 of material having a tensile strength sufficient to resist tearing when exposed tensile loads from various directions. (Hereinafter, “underlayment 100” shall encompass either underlayment 100a or 100b; and hereinafter, “woven scrim 108” shall encompass either scrim 108a or 108b).

In one example, the woven scrim 108 is of tapes 114, 116 or fibers 115, 117 configured to form a mesh having substantial strength in multiple directions. In one example, the orientation of the thermoplastic tapes 114, 116 or fibers 115, 117 are selected to optimize their tensile strength or be of any other interwoven configuration. The tapes 114, 116 or fibers 115, 117 can be of any cross-sectional shape and size, depending upon the desired tensile characteristics of the woven scrim 108. In one example, the scrim 108 used in this disclosure is formed of polypropylene tapes 114, 116 or fibers 115, 117 interwoven to form a web that provides substantial strength to the roofing underlayment 100 in multiple directions.

In one example of the present disclosure, the woven scrim 108 has an average basis weight of about 35-50 g/m², about 40-45 g/m², or about 41-43 g/m².

### Nonwoven Sheet Examples

In one example, the nonwoven sheet 112 is formed of randomly disposed polymer fibers that are bonded to one another to form a nonwoven web. The nonwoven sheet 112, when bonded to the woven scrim 108, provides high tenacity and relatively low elongation that provide the strength and other physical properties required for a roof underlayment.

The nonwoven sheet 112 may comprise polyolefin alone or in combination with polyester, rayon and polyamide fibers could also be 100% polyester. The nonwoven sheet 112 may be spunbond, thermal point-bonded or ultrasonically-bonded (for nonwovens); chemically-bonded; or hydraulically-entangled. In one example, the nonwoven sheet 112 consists of polypropylene polyethylene or polyethylene copolymers.

In one example, the surface of the nonwoven sheet 112 facing away from the woven scrim 108 is configured to function as an anti-skid surface. This anti-skid function provides secure footing while walking on the underlayment during installation and/or reconstruction of the roof thereby eliminating an extra, separate layer of anti-skid material to the surface of the nonwoven sheet 112. In one example, the nonwoven sheet 112 comprises thermoplastic olefins of ethylene copolymers.

In one example, additional anti-skid material can be incorporated into the thermoplastic polyolefin 112 of underlayment 100. The nonwoven sheet 112 can also include UV resistant material in the thermoplastic polyolefin 112 to prevent degradation from exposure to sunlight. In one example, UV resistance is incorporated into the thermoplastic polyolefin 112 and the scrim 108.

In one example of the present disclosure, the polyolefin sheet has an average basis weight of about 15-25 g/m², about 16-19 g/m², or about 17-18 g/m².

### Functional Coating

Functional coating 210, e.g., of waterproof and/or tacky non-skid material is deposited on one MD surface of woven scrim 108. In one example, functional coating 210 is directly deposited on one MD surface of the woven scrim 108. Functional coating 210 can be a propylene-ethylene copolymers or other low molecular weight polyethylene copolymers, such as metallocene plastomer or elastomers, for example VERSIFY™ 4000 or 4200 (Dow, Midland, Mich.) or VISTAMAXX™ (Exxon, Houston, Tex.). In one example, the functional coating 210 provides surface with a coefficient of friction with a minimum value of 0.5 to 0.9, for example 0.5 to 0.7, or for example 0.50, 0.70, 0.73, or 0.80 as measured in accordance with ASTM F-1679 under dry conditions

The functional coating 210 can comprise one or more additives, for example, U.V. stabilizers, anti-block additives, colorants, and pigments, to the extent that such additives do not interfere with the any properties of the coatings or add weight to the underlayment 100. When used, additives can be added as part of a color masterbatch.

In one example of the present disclosure, the functional coating 210 is provided at an average basis weight of about 20-40 g/m², about 22-35 g/m², or about 25-30 g/m².

### Underlayment Examples

The underlayment of this disclosure, of a laminate construct having a woven scrim 108 ultrasonically bonded to a nonwoven on one side, and a functional coating 210 on an opposing side as described above, provides a lightweight, strong, underlayment. In one example, woven scrim 108 is bonded with nonwoven sheet 112 in a manner such that it becomes essentially a single composite sub-laminate 250 sheet for receiving a functional coating 210. In another example, woven scrim 108 is functionally coated with functional coating 210 which is then bonded with nonwoven sheet 112 directly provide the underlayment.

In one example, the total thickness of the underlayment is configured to be about 5-20 mils, preferably about 5-10 mils. In one example, the total average weight, including the scrim 108, nonwoven sheet 112 and functional coating 210 of the underlayment described herein does not exceed about 85-100 g/m², does not exceed about 87-97 g/m², does not exceed about 89-95 g/m². As such, the presently disclosed underlayment is less than 30%, 20%, or 10% the weight of conventional felt paper underlayment. In one example, the roll 233 is configurable to weigh less than about 10 kilograms (about 22 pounds). A roll of the presently disclosed underlayment with a weight of less than 10 kgs can be configured to be about 4 feet in width (or height) and 250 feet in length when unrolled so as to cover about 1000 square feet of roof. Other roll dimensions of width/height and length for the underlayment are contemplated with the scope of this disclosure. Thus, the underlayment of this disclosure offers a considerable improved ease of installation and overall installation cost.

In one example, the underlayment on the deck-facing side has a grab tensile strength of at least 13.6 kg-force (about 133 Newtons; 30 pounds), or at least 18.2 kg-force (about 178 Newtons; 40 pounds) in at least one of the machine direction (MD) or the cross-machine direction (CD). In another example, the underlayment 100 has a grab tensile strength of at least 27.2 kg-force (about 267 Newtons; 60 pounds) in at least one of the MD and the CD. In one example, the underlayment 100 on the deck-facing side has a grab tensile strength of at least 16.8 kg-force (about 165 Newtons; 37 pounds) in the CD.

In one example, the underlayment is configured to maintain a tensile strength of more than 357 kg-force/m (about 3500 N/meter; about 20 pound foot/inch width (lbf/in)) after simulated exposure to accelerated aging and sunlight. In another example, the underlayment 100 is configured to have an acceptable breaking strength, when tested pursuant to standards established by the American Society of Testing Materials (ASTM), i.e., ASTM D146. In another example, alone or in combination with the above grab and/or tensile strength, the underlayment 100 is configured to provide performance above the ASTM D226 criteria of about 5.5 kg-m (about 40 lb-ft) in machine direction and about 2.8 kg-m (about 20 lbf) for cross-machine direction.

The present underlayment 100, alone or in combination with any of the above tensile properties, is configured to provide acceptable weather resistance according to ASTM D4869 per AC 48.

### Manufacturing Methods

A preferred method of manufacture includes use of a roll calendaring process where nonwoven 112 material and woven scrim 108, or functionally coated woven scrim 208, are run through a horn 39 and anvil roller 35. As these materials pass thru the horn 39 and anvil, the nonwoven 112 material and woven scrim 108 and/or functional coating are mechanically bonded together. Thus, in one example a sub-laminate body 250 (nonwoven 112 material and woven scrim 108 mechanically bonded together) is prepared and configured for receiving the functional coating 210 so as to provide the underlayment. In another example, nonwoven 112 material functionally coated woven scrim 208, are mechanically bonded together to directly provide the underlayment.

In one example, the underlayment is formed in a manner such that the nonwoven 112 does not substantially impregnate the woven scrim 12 during bonding.

The composite laminate underlayment of this disclosure has many additional industrial uses, including protective apparel, construction substrates, envelopes, medical packaging and graphics, such as billboards.

As shown in FIG. 1, a composite underlayment of this disclosure is ideally suitable for building construction. It is generally lightweight, for example, less than 100 grams/m², and less than about 95 grams/m², and can be disposed on building sidewalls, or beneath tile roofing material 12 above the roofing deck 16 of a building. The composite underlayment 100 can be printed with the brand name of the company producing it, or other graphics, or indicia.

The use of ultrasonic bonding allows the nonwoven layer to be bonded to the woven layer without the use of an adhesive layer, such as an extrusion coating or glue layer. Therefore, ultrasonic welding allows for the reduction in the total weight and cost of the underlayment by eliminating this bonding layer. In one example, ultrasonic welding creates bonds between contact points of both the nonwoven sheet 112 and the woven scrim 108 that provide weld points 120. In one example, an ultrasonic bonding process was used to bond the nonwoven sheet 112 to the woven scrim 108. Thus, in one example of the present disclosure, an adhesive or adhesive layer is excluded from the underlayment disclosed herein.

### Functional Coating—Extrusion Coating

Lamination of the deck-facing side of woven scrim 108 with functional coating 210 can be carried out i by extrusion coating of the woven scrim 108 and nonwoven layer 112 or the woven scrim can be extrusion coated with the functional layer prior to the ultrasonic lamination of the nonwoven to the scrim. The lamination can involve one or more methods of thermal lamination or adhesive lamination. In one example, the functional coating 210 is applied by extrusion coating to the deck-facing side of woven scrim 108 to provide about 15 to about 40 g/m² of functional coating 210, as it is difficult to extrusion coat less than 15 g/m² of functional coating 210 without introducing pinholes holes into the functional coating 210. Functional coatings of greater than 40 g/m² add additional weight to the underlayment 100 without noticeable performance improvement. In an exemplary extrusion coating, functional coating 210 is subjected to elevated temperatures and pressures so as to soften and/or melt the material (e.g., pellets) and the softened or melted functional layer 210 is brought into engagement with the deck-facing side of woven scrim 108, e.g., using for example a nip roll 233.

In one example, an extrusion coating process is used, whereas the polymer that forms the functional coating 210 is melted at an elevated temperature to reduce its viscosity and coated onto the deck-facing side of woven scrim 108 and passed through a nip, where the melt is pressed into engagement with the woven scrim 108 to a desired thickness.

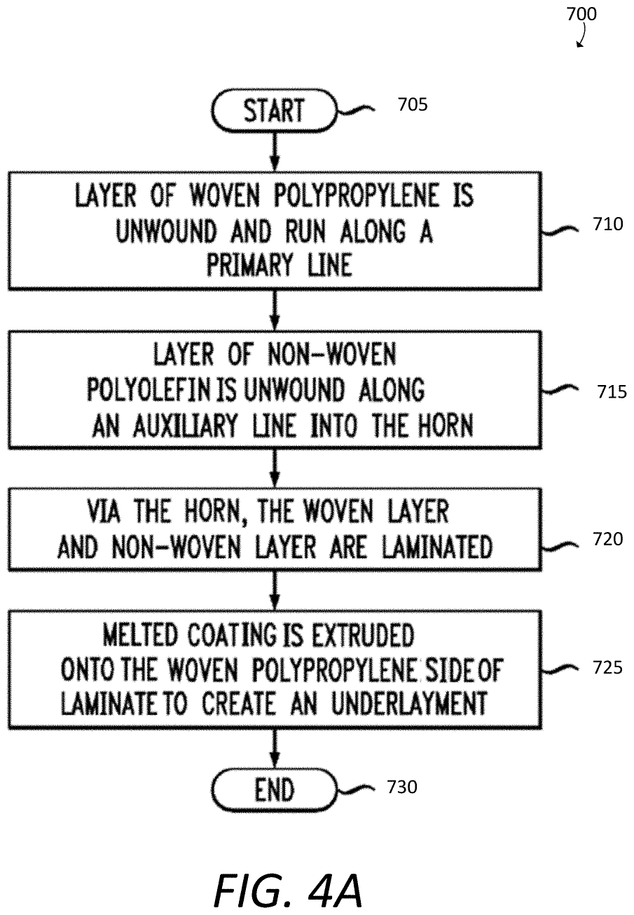

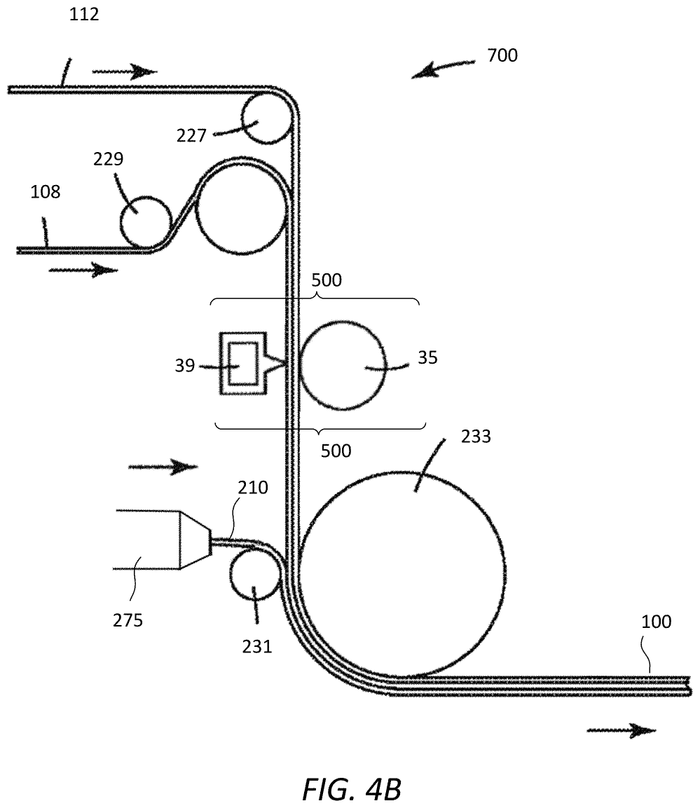

With reference to FIGS. 4A and 4B, an exemplary process flow depicts the bonding of the nonwoven sheet 112 with the woven scrim 108 in the formation of the sub-laminate 250 of underlayment 100 of the present disclosure, as well as the subsequent functional layer 210 coating. Process flow steps need not be performed in the sequence illustrated in FIGS. 4A and 4B, and some of the steps may be performed substantially simultaneously. As presented in FIG. 4A and with reference to FIG. 4B, upon starting method 700 at step 705, a woven scrim 108 of thermoplastic, for example, is unwound and run through a single pass on a primary process line 227 as in step 710. Optionally, woven scrim 108 can be pretreated, such as corona, flame or UV oxidizing a top surface of the woven scrim 108.

As shown in step 715, nonwoven thermoplastic 112, such as, for example, 15-20 g/m² spun-bonded nonwoven polyethylene, is unwound and run on an auxiliary line 227 into a sonic welding device 500 a time substantially simultaneous to the woven scrim 108 entering the sonic welding device 500 via roll 229. In the sonic welding device 500, horn 39 and anvil roller 35 provide sonic pressure to the woven scrim 108 and the nonwoven thermoplastic 112 is thermally laminated to the woven scrim 108 as in step 720.

Bonding by ultrasonic bonding equipment 500 bonds the woven scrim and nonwoven sheet together providing a sub-laminate 250, usually in a localized bond pattern of welds 120 through the web. Bonding can be provided in any pattern as provided on the anvil roller 35.

Ultrasonic welding through the use of a stationary horn 39 and a patterned anvil roll 233 can be employed as is known in the art, such as U.S. Pat. No. 5,817,199, however, any other ultrasonic welding technique can be used in the present disclosure.

The sub-laminate 250 can be rolled and/or stored for later extrusion coating. Alternatively, the sub-laminate 250 is used in a continuous process to dispose the functional coating 210 on the woven side of the sub-laminate 250. Thus, in one example, molten functional coating 210, such as molten ethylene plastomer copolymer, is extruded through a die 275 onto optional roller 231 and brought into contact with the woven scrim 108 side of the sub-laminate 250, as in step 725, so as to provide about 25-30 g/m² of functional coating 210 to the sub-laminate 250. The resultant underlayment 100 is taken-up, which can optionally be pulled into a nip of two or more nip rollers (not shown), wherein the pressure of the optional nip of two or more nip rollers is set to control thickness and/or surface properties.

Once ultrasonically bonded and thermally laminated, the resulting underlayment 100 is cured and/or cooled and is then is ready for deployment with the process ending at step 730.

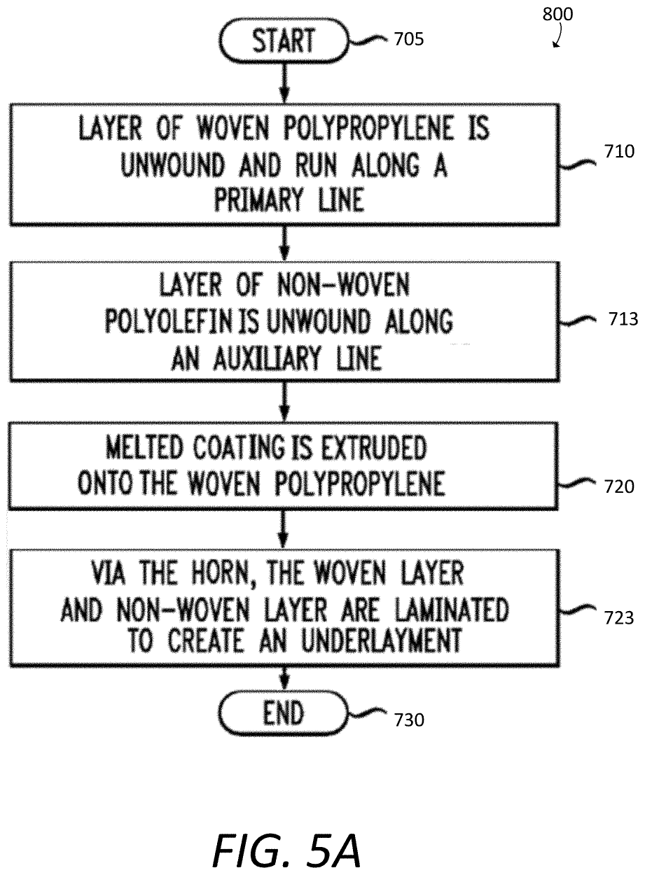

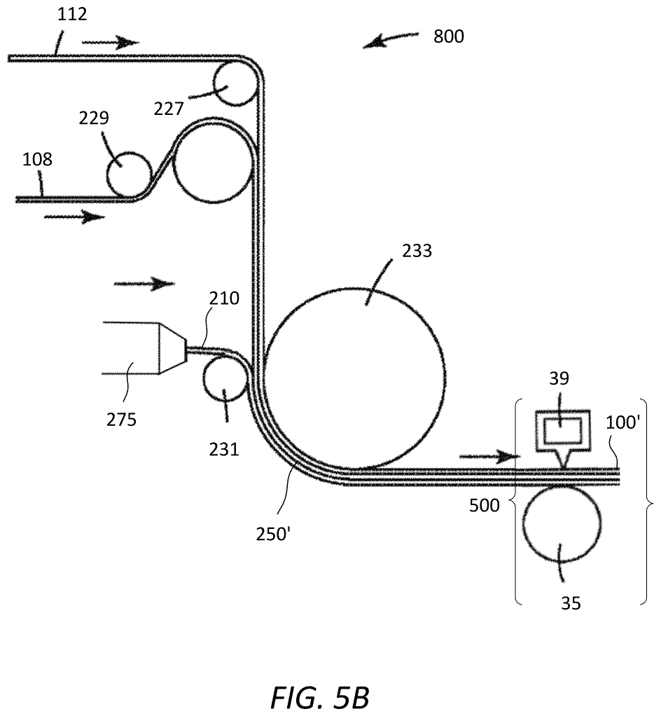

With reference to FIGS. 5A and 5B, an exemplary process flow depicting the formation of underlayment 100′ of the present disclosure is provided. Underlayment 100′ is similar to that of underlayment 100 but for the ultrasonic bonding step being after the introduction of the functional layer 210 coating to woven scrim 108. As presented in FIG. 5A and with reference to FIG. 5B, upon starting method 800 at step 705, a woven scrim 108 of thermoplastic, for example, polypropylene, is unwound and run through a single pass on a primary process line 227 as in step 710. Optionally, woven scrim 108 can be pretreated, such as corona, flame or UV oxidizing a top surface of the woven scrim 108.

In step 713, nonwoven 112, such as, for example, 15-20 g/m² spun-bonded nonwoven polyethylene, is unwound and run on an auxiliary line 227 and joined with the woven scrim 108 to provide sub-laminate 250′. Molten functional coating 210, such as molten ethylene plastomer copolymer, is extruded through a die 275 onto optional roller 231 and brought into contact with the woven scrim 108 side of the sub-laminate 250′, as in step 720, so as to provide about 25-30 g/m² of functional coating 210 to the sub-laminate 250′.

Functionally coated sub-laminate 250′ enters the sonic welding device 500 via roll 233. In the sonic welding device 500, horn 39 and anvil roller 35 provide sonic pressure to the functionally coated woven scrim 208 and the nonwoven thermoplastic 112 is thermally laminated to the functionally coated woven scrim 208 as in step 723.

The resultant underlayment 100′ is taken-up, which can optionally be pulled into a nip of two or more nip rollers (not shown), wherein the pressure of the optional nip of two or more nip rollers is set to control thickness and/or surface properties and is then is ready for deployment with the process ending at step 730.

An example of the present disclosure is directed toward an underlayment 100, 100′ that provides a lightweight underlayment product suitable as a roof underlayment. In one example, the functional coating 210 functions as an anti-skid coating providing anti-skid properties to the roofing underlayment 100, 100′. Suitable thermoplastic olefin resins include, but are not limited to, EPDM, low density polyethylene (LDPE), linear low density polyethylene (LLDPE), plastomer or elastomer). Polyolefin coatings are selected to be compatible with the woven scrim 108 surface to which they are applied. In one example, the polyolefin coating is VISTAMAX™ (ExxonMobil, Houston, Tex.) or VERSIFY™ (Dow Chemical Co., Midland, Mich.).

The functional coating 210 of the present disclosure is suitable for extrusion coating onto scrim 108. Extrusion coating of a functional coating 210 onto scrim 108 may be accomplished by melting the functional coating precursor material in an extruder and extruding through a film die 275, for example, onto the scrim 108. The molten functional coating polymer and scrim 108 can be transported between a nip roll 231 and a chill roll 233 to cool the molten functional coating 210 and to ensure adequate bonding thereto.

The disclosure is illustrated, but not limited by the following examples: which follow. It should be noted that the color of pigment included in the coatings can vary, as long as the percentage of the resin, or the let-down-ratio, remains the substantially the same.

### EXAMPLES

A roofing underlayment 100 according to the present disclosure comprised of a woven polypropylene scrim 108, a nonwoven polyolefin sheet and a polyethylene-based functional coating 210 was prepared. The scrim 108 comprised upper and lower coating layers corresponding with the non-deck facing and deck facing surfaces of the scrim 108. The polypropylene scrim 108 used was a woven polypropylene with 8 tapes per inch. The upper surface of the scrim 108 was ultrasonically bonded to the nonwoven sheet 112 first as depicted in FIGS. 4A, 4B. The nonwoven sheet 112 was comprised of an upper layer, or non-deck facing surface and a lower layer directly adjacent the woven non-deck facing surface. Ultrasonic bonding was performed using a Herman Ultrasonic bonder (Chicago, Ill.), using a line speed of 5 m/min, a pressure of 3 BAR and a dotted anvil pattern covering 4 welds per inch in the cross direction and 3 welds per inch in the machine direction. The functional coating 210 of VISTAMAX™ or VERSIFY™ product (thermoplastic olefin resin or plastomer/elastomer), was extrusion coated at temperature above the melt temperature of the VISTAMAX™ or VERSIFY™ to the bonded scrim/nonwoven sheet.

Alternatively, scrim 108 comprised upper and lower coating layers corresponding with the non-deck facing and deck facing surfaces of the scrim 108. The polypropylene scrim 108 used was a woven polypropylene with 8 tapes per inch. The nonwoven sheet 112 was comprised of an upper layer, or non-deck facing surface and a lower layer directly adjacent the woven non-deck facing surface. Scrim 108, nonwoven sheet 112 were brought together and functional coating 210 of VISTAMAX™ or VERSIFY™ product (thermoplastic olefin resin or plastomer/elastomer), was extrusion coated at temperature above the melt temperature of the VISTAMAX™ or VERSIFY™ to scrim 108 as depicted in FIGS. 5A, 5B. Scrim 108, nonwoven sheet 112 and functional coating 210 were ultrasonically bonded together using a Herman Ultrasonic bonder (Chicago, Ill.), using a line speed of 5 m/min, a pressure of 3 BAR and a dotted anvil pattern covering 4 welds per inch in the cross direction and 3 welds per inch in the machine direction.

In one example, the composite laminate sheet as disclosed herein is positioned on a roof deck 16 so that the surface of nonwoven sheet 112 faces upwardly (non-deck facing) so as to function as an anti-slip surface, and the functional coating 210 of the composite laminate underlayment 100 faces towards the roof deck 16 and functions as a non-skid surface. Nonwoven sheet 112 and functional coating 210 can be color-coded and/or of different colors for facilitating proper orientation of the surfaces of composite laminate underlayment 100.

A roofing underlayment 100 has been described. It will be understood by those skilled in the art that the present disclosure may be embodied in other specific forms without departing from the scope of the disclosure disclosed and that the examples and examples described herein are in all respects illustrative and not restrictive. Those skilled in the art of the present disclosure will recognize that other examples using the constructs described herein are also possible.

Any reference to claim elements in the singular, for example, using the articles “a,” “an,” or “the” is not to be construed as limiting the element to the singular. All numerical ranges are inclusive of their endpoints and non-integral values between the endpoints unless otherwise stated.

I claim:

1. An underlayment comprising:
a woven scrim having a first surface defined by a length and a width, and a second opposing surface separated from the first surface by a thickness,
a nonwoven sheet adjacent the first surface; and
a functional coating attached to the second surface;
wherein the nonwoven sheet is ultrasonically bonded to the first surface.

2. An underlayment as described in claim 1, wherein the nonwoven sheet is directly adjacent the woven scrim and the functional coating is directly attached to the second surface.

3. An underlayment as described in claim 1, wherein the woven scrim comprises polypropylene or polypropylene copolymer, optionally with one or more UV resistant, antimicrobial, anti-slip, anti-skid, or colorant additives.

4. An underlayment as described in claim 1, wherein the woven scrim comprises interwoven tape or fiber arranged in a warp and a weft pattern

5. An underlayment as described in claim 1, wherein the woven scrim has an average basis weight of about 35-50 g/m².

6. An underlayment as described in claim 1, wherein the nonwoven sheet comprises polypropylene, polyester, polyethylene or polyethylene copolymer, optionally with one or more UV resistant, antimicrobial, anti-slip, anti-skid, or colorant additives.

7. An underlayment as described in claim 1, wherein the nonwoven polyolefin sheet has an average basis weight of about 15-25 g/m².

8. An underlayment as described in claim 1, wherein the functional coating comprises polypropylene and copolymers or terpolymers of polypropylene EPDM, low density polyethylene (LDPE), linear low density polyethylene (LLDPE), plastomer or elastomer, optionally with one or more UV resistant, antimicrobial, anti-slip, anti-skid, or colorant additives.

9. An underlayment as described in claim 1, wherein the functional coating is applied at an average basis weight of about 15-40 g/m².

10. An underlayment as described in claim 1, wherein an average total basis weight of the woven scrim, nonwoven sheet, and functional coating is less than 100 g/m².

11. An underlayment as described in claim 1, wherein an average total basis weight of the woven scrim, nonwoven sheet, and functional coating is less than 90 g/m².

12. An underlayment as described in claim 1, wherein the underlayment comprises anti-slip properties and anti-skid properties on the opposing first and second surfaces.

13. An underlayment consisting of:
a woven scrim having a first surface defined by a length and a width, and a second opposing surface separated from the first surface by a thickness,
a nonwoven sheet adjacent the first surface; and
a functional coating attached to the second surface;
wherein the nonwoven sheet is ultrasonically bonded to the first surface.

14. An underlayment as described in claim 13, wherein the nonwoven sheet is directly adjacent the woven scrim and the functional coating is directly attached to the second surface.

15. An underlayment as described in claim 13, wherein the woven scrim consists of polypropylene or polypropylene copolymer, optionally with one or more UV resistant, antimicrobial, anti-slip, anti-skid, or colorant additives.

16. An underlayment as described in claim 13, wherein the woven scrim comprises interwoven tape or fiber arranged in a warp and a weft pattern

17. An underlayment as described in claim 13, wherein the woven scrim has an average basis weight of about 35-50 g/m².

18. An underlayment as described in claim 13, wherein the nonwoven sheet consists of polypropylene, polyester, polyethylene or polyethylene copolymer, optionally with one or more UV resistant, antimicrobial, anti-slip, anti-skid, or colorant additives.

19. An underlayment as described in claim 13, wherein the nonwoven polyolefin sheet has an average basis weight of about 15-25 g/m².

20. An underlayment as described in claim 13, wherein the functional coating consists of polypropylene and copolymers or terpolymers of polypropylene EPDM, low density polyethylene (LDPE), linear low density polyethylene (LLDPE), plastomer or elastomer optionally with one or more UV resistant, antimicrobial, anti-slip, anti-skid, or colorant additives.

21. An underlayment as described in claim 13, wherein the functional coating is applied at an average basis weight of about 15-40 g/m².

22. An underlayment as described in claim 13, wherein an average total basis weight of the woven scrim, nonwoven sheet, and functional coating is less than 100 g/m².

23. An underlayment as described in claim 13, wherein an average total basis weight of the woven scrim, nonwoven sheet, and functional coating is less than 90 g/m².
